(19) United States
(12) Patent Application Publication
(10) Pub. No.: US 2006/0276232 A1
(43) Pub. Date: Dec. 7, 2006

(54) Cell phone for the young, elderly and disabled

(76) Inventor: Tamara L. Engevold, Aloha, OR (US)

Correspondence Address: MARGER JOHNSON & MCCOLLOM, P.C., 210 SW MORRISON STREET, SUITE 400, PORTLAND, OR, 97204, US

(21) Appl. No.: 10/911,886

(22) Filed: Aug. 4, 2004

Related U.S. Application Data
(60) Provisional application No. 60/493,098, filed on Aug. 5, 2003.

(51) Int. Cl. H04B 1/38; H04M 1/00

(52) U.S. Cl. 455/564

(57) ABSTRACT

A cellular telephone includes a processor with coupled memory, a message speaker, and a plurality of telephone numbers and a plurality of audible messages stored in memory. A plurality of buttons is provided, each button associated with one of the plurality of audible messages and one of the plurality of telephone numbers, each button causing the cellular telephone to play the audible message associated with the button when the button is pressed. A send button causes the cellular telephone to dial the telephone number associated with one of the plurality of buttons after the one of the plurality of buttons was pressed. The telephone restricts outgoing call usage based on selectably programmed buttons.

### CROSS REFERENCE TO RELATED APPLICATIONS

This application claims priority from U.S. Provisional Application No. 60/493,098, filed on Aug. 5, 2003, and which is incorporated by reference.

### BACKGROUND OF THE INVENTION

The present invention is related to the field of cellular telephones, and more specifically to a cellular telephone particularly adapted for use by children, the elderly, and the disabled.

Cellular telephones have become prevalent in industrialized countries. Such telephones have evolved to become smaller and offer an increasing number of features and capabilities.

The down-sizing of modem cellular telephones and proliferation of buttons and functions therein, however, makes them ill-suited for use by children, the elderly, and physically or mentally handicapped.

Further, parents are increasingly concerned with safety of their children and often provide them with cellular telephones in order to maintain contact when separated. Because the telephone may be used to make or receive calls by any user, the child may use the telephone injudiciously or permit others to use it, adding to the parent's total cost of cellular service.

Consequently, a need exists for a simplified cellular telephone that can be readily and conveniently used by the elderly, children, and the disabled. A further need exists for a cellular telephone that can be used to contact the user but that provides limited outgoing call use.

The invention will become more readily apparent from the following Detailed Description, which proceeds with reference to the drawings, in which:

### BRIEF DESCRIPTION OF THE DRAWINGS

FIG. 1 is a front-view diagram of a first embodiment of the present invention having a flip-style body in an open position.

FIG. 2 is a side-view diagram of a first embodiment of FIG. 2.

FIG. 3 is a front-view diagram of a first embodiment of the present invention in a closed position.

FIG. 4 is a side-view diagram of a first embodiment of FIG. 3.

### DETAILED DESCRIPTION OF THE PREFERRED EMBODIMENT(S)

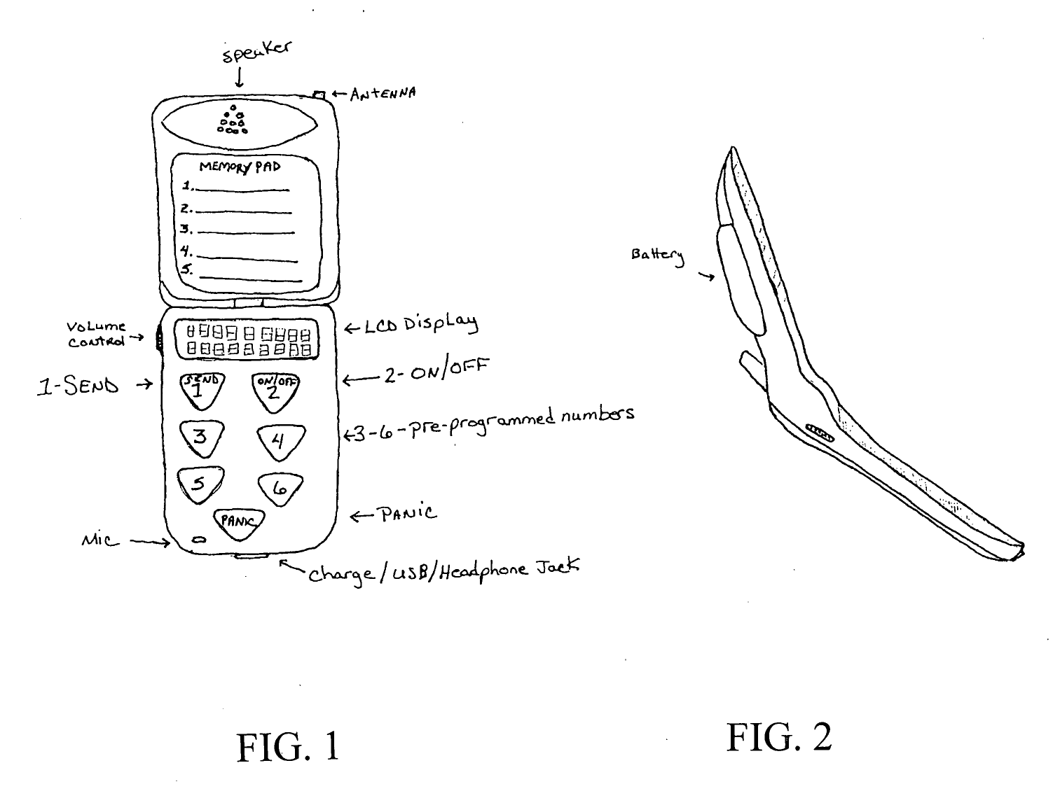

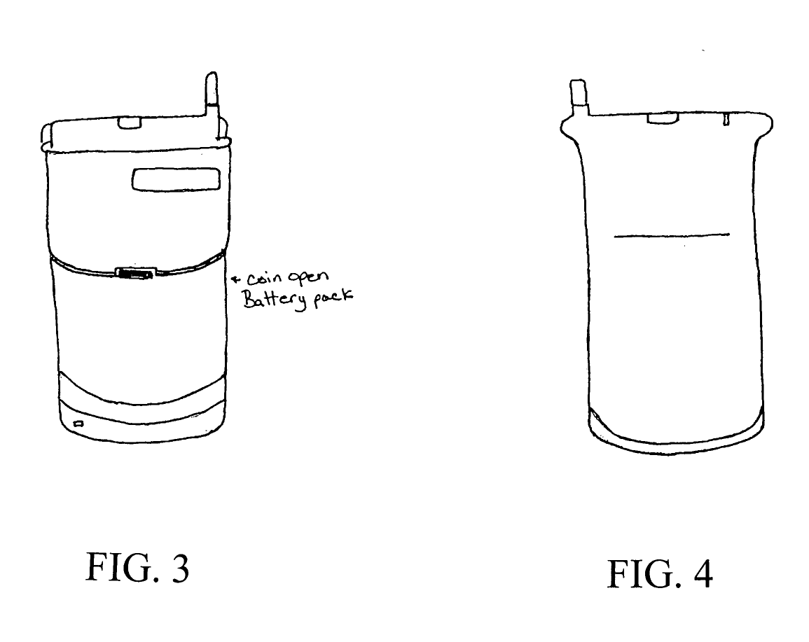

Turning to FIG. 1, the present invention generally provides a cellular telephone body. The body of the present invention can be a linear or flip-style case. In the flip-style embodiment, opening the phone activates a call answer to answer an incoming call.

The inventive telephone further has a display, e.g. a liquid-crystal display, for displaying information. Such information can include but is not limited to a message, identity of a button depressed, and information concerning an incoming and/or outgoing telephone call.

Further provided are earpiece and a microphone adapted for use in conventional telephony, and a message speaker.

Internally provided is a microprocessor, of the type commonly used in cellular telephones and well-known in the art. Coupled to the microprocessor is a memory, suitable for storage of electronic data corresponding to telephone numbers, graphic and/or audible messages, identities, call log capabilities, and other functions.

A plurality of buttons are disposed on the telephone. The phone has a limited number of buttons; in a preferred embodiment, there are seven buttons. These buttons preferably are larger than the average cell phone's buttons for easier use. The buttons may be identified by numbers, pictures, icons, Braille or other means. The size, shape, coloring and labeling of the buttons can be customized for the particular user.

The functions of the plurality of buttons is described below. While the cited functions are desirable, it should be noted that other functions can be substituted.

On/Off: Controls power on/off for phone.

SEND Button: The user presses this button to activate an outgoing call. The SEND button also may be designed for voice activation. For example, the user may press SEND, say “Call Home” and the call would be activated.

PANIC Button: This button, when pressed, will automatically power up the phone if it is off and call out to the desired number without pressing send. It may be set up with the following options that the purchaser of the phone would select:
1. Calls 911 emergency services. The purchaser preferably will first register the phone with local authorities, enabling emergency services to have the carrier's information upon receipt of the call (name, age, first point of contact, address, etc.). This could be used to initiate the Amber Alert systems employed now by many states.
2. Calls security company. A subscription security company would have the information on the carrier and can begin emergency notification.
3. Any emergency number the purchaser desires to have programmed as an emergency contact.

Buttons preferably can be programmed through computer software and a universal serial bus (USB) connector. A security password preferably is required, making the phone virtually useless if stolen or lost. The phone will only be able to call out to the pre-programmed numbers. This outgoing-call restriction enables the user to have important contact with family, doctors, emergency services, etc. The phone will allow incoming calls when powered on, but it can only access (i.e., place an outgoing call) those numbers which have been pre-programmed into the phone.

An audible message preferably is emitted from the message speaker when a pre-programmed button is pressed. The audible message can indicate whom the user is calling. For example, when the user presses the first button (programmed by the purchaser of the phone to call the user's home phone number), the user can hear “Call home”. The phone also may display calling information on an LCD screen. If this home telephone number is the number the user has chosen, the user may then press the send button and activate the call. If another number is intended to be called, the user may press the next pre-programmed button and re-initiate the above sequence.

Global positioning satellite (GPS) tracking is provided. Tracking preferably is enabled at all times, in order to locate the phone. The GPS module preferably has a separate battery power supply. Tracking can be made available through the internet, preferably with a security password.

A volume control dial is located on side of phone so user can easily adjust volume while speaking, without having to pause and look at the phone for the control. The volume control is anticipated to be only for the receiver portion of the phone, although other uses are permissible. Audible messages programmed into the buttons preferably are emitted at higher volume than the receiver output. This disparity is intended to ensure that the user can hear the number they have selected, without having to hold the phone to their ear. An output jack for a headphone or a hearing device also can be provided.

A case can be provided for the phone; such case preferably is well-padded to protect the cell phone against the atypical abuses it would be exposed to in the hands of a youngster. The case also should provide easy placement and removal of phone. Various clips, Velcro® and other well-known means and case designs can be utilized for mounting on bikes, clips for backpacks, purses, belts and belt loops, pocket clips, even straps that a child may be able to snap on for carrying while playing.

The phone is preferably used by children 6-15 years of age, senior citizens, and mentally or physically disabled individuals. Its design and layout provide simplicity, ease to use, accessibility, and emergency communications.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and subcombinations of the various elements, features, functions and/or properties disclosed herein.

What is claimed is:

1. A cellular telephone comprising:
a processor and a memory coupled thereto;
an earpiece speaker and a microphone;
a message speaker;
a plurality of telephone numbers stored in said memory;
a plurality of audible messages stored in said memory;
a plurality of buttons, each button associated with one of the plurality of audible messages and one of the plurality of telephone numbers, each button causing the cellular telephone to play the audible message associated with the button when the button is pressed; and
a send button structured to cause the cellular telephone to dial the telephone number associated with one of the plurality of buttons after the one of the plurality of buttons was pressed.

2. The cellular telephone of claim 1, further comprising:
a panic function associated with one of said buttons, said panic button configured to cause a signal to be transmitted to an emergency responder.

3. The cellular telephone of claim 1, further comprising an interface configured to facilitate coupling of the cellular telephone to a computing device.

4. The cellular telephone of claim 1 wherein the cellular telephone is configured to make outgoing calls only to one of the plurality of telephone numbers stored in the memory.

5. The cellular telephone of claim 4 wherein the plurality of telephone numbers are programmable by an administrative user.

6. The cellular telephone of claim 1, further comprising a global positioning system unit.

7. The cellular telephone of claim 6 wherein said global positioning system unit is powered by a GPS power source independent from a telephone battery source.

8. The cellular telephone of claim 1, further comprising a plurality of buttons structured to facilitate ready actuation by a dexterity-impaired user.

8. The cellular telephone of claim 1 wherien at least one of the plurality of buttons has a Braille character affixed thereon, said Braille character corresponding to a telephone number stored in the memory and associated with said button.

8. The cellular telephone of claim 1 wherein at least one of the plurality of buttons has a graphic affixed thereon, said graphic corresponding to a stored number associated with said button.

10. The cellular telephone of claim 1, further comprising a rotating dial structured to control a volume of a sound emanating from an earpiece speaker.

11. The cellular telephone of claim 10 wherein the rotating dial is structured to control a volume of a sound emitting from an earpiece speaker without controlling a volume of a sound emitting from the message speaker.

12. A cellular telephone, comprising:
a global positioning system (GPS) unit; and
a power supply structured to supply power only to the GPS unit.

13. The cellular telephone of claim 12 wherein said GPS unit is enabled irrespective of telephone power status.

14. A cellular telephone, comprising a panic button structured to, if the cellular telephone is off, turn on the cellular telephone and dial a pre-selected number.

15. The cellular telephone of claim 14, further comprising an interface to a computer for programming the button to be associated with an administrative user-selectable emergency responder telephone number.

16. The cellular telephone of claim 14, further comprising a security password to prevent unauthorized changes to the emergency responder telephone number.

17. The cellular telephone of claim 14, further comprising:
a memory; and
instructions stored in the memory and operative to transmit personal information of a user to an administrative user-selectable emergency responder
